(19) United States
(12) Patent Application Publication
(10) Pub. No.: US 2021/0324137 A1
(43) Pub. Date: Oct. 21, 2021

(54) PEROXIDE CURABLE HIGHLY FLUORINATED POLYMERS COMPRISING AN INTERNAL FLUORINATED PLASTICIZER AND ARTICLES THEREFROM

(71) Applicant: 3M INNOVATIVE PROPERTIES COMPANY, St. Paul, MN (US)

(72) Inventors: Edward E. Cole, Woodbury, MN (US); Tatsuo Fukushi, Woodbury, MN (US); Miguel A. Guerra, Woodbury, MN (US); Michael H. Mitchell, Woodbury, MN (US); Sean M. Smith, Woodbury, MN (US)

(21) Appl. No.: 17/268,972

(22) PCT Filed: Aug. 23, 2019
(86) PCT No.: PCT/IB2019/057120

§ 371 Date: Feb. 17, 2021

Related U.S. Application Data
(60) Provisional application No. 62/723,264, filed on Aug. 27, 2018.

(51) Int. Cl. C08G 65/00; C08L 27/18; C08L 27/20; C08K 3/04; C08K 3/34; C08K 3/36; C08K 5/14; C08K 5/3492; C08K 5/00

(52) U.S. Cl. CPC C08G 65/007; C08L 27/18; C08L 27/20; C08K 3/04; C08G 2650/48; C08K 3/36; C08K 5/14; C08K 5/34924; C08K 5/0016; C08K 3/346

(57) ABSTRACT

Described herein is a functionalized oligomeric compound, which can be polymerized into a peroxide curable highly fluorinated polymer. The functionalized oligomeric compound is at least one of a monofunctional compound of formula (I) R-L-X having a number average molecular weight of 1000-16,000 g/mol; or a difunctional compound of formula (II) is R¹-(L-X¹)₂ having a number average molecular weight of 1000-6000 g/mol; where: X comprises at least one of: —CH═CH₂, —CH₂CH═CH₂, —OCH═CH₂, —OCH₂CH═CH₂, —OCH₂C(CH₃)═CH₂, —C(CH₃)═CH₂, and —OCF═CF₂; X¹ comprises at least one of: —CH═CH₂, —CH₂CH═CH₂, —OCH═CH₂, —OCH₂CH═CH₂, —OCH2C(CH₃)═CH₂, and —C(CH₃)═CH₂; L comprises at least one of a bond, —CH₂OC(═O)—, —CH₂OC(═O)NHCH₂CH₂OC(═O)—, and —C(═O)NHCH₂CH₂OC(═O)—; R is a monovalent perfluoro polyether alkyl group; and R¹ is a divalent perfluoro polyether alkylene group. Such functionalized oligomeric compounds may be used as improve the processability of highly fluorinated polymers and may improve the physical properties of the resulting cured fluoropolymer.

### TECHNICAL FIELD

Compositions comprising a peroxide curable highly fluorinated polymer along with a functionalized fluorinated oligomer are described along with methods of curing and articles therefrom.

### SUMMARY

There is a desire to identify functionalized plasticizing agents for use in peroxide curable fluoropolymer compositions which are chemically bound to the fluoropolymer.

In one aspect, a composition is described, the composition comprising:
(a) a curable highly fluorinated polymer comprising at least one of an iodine cure-site, a bromine cure-site, and a nitrile cure-site;
(b) 4 to 25 parts of a curable oligomer per 100 parts of the curable highly fluorinated polymer, wherein the curable oligomer is
   (i) a monofunctional compound of formula (I) R-L-X having a number average molecular weight of 1000-16,000 g/mol,
   (ii) a difunctional compound of formula (II) is R¹-(L-X¹)₂ having a number average molecular weight of 1000-6000 g/mol, or
   (iii) mixtures thereof;
      where:
      X comprises at least one of:
      —CH═CH₂, —CH₂CH═CH₂, —OCH═CH₂, —OCH₂CH═CH₂, —OCH₂C(CH₃)═CH₂,
      —C(CH₃)═CH₂, and —OCF═CF₂;
      X¹ comprises at least one of:
      —CH═CH₂, —CH₂CH═CH₂, —OCH═CH₂, —OCH₂CH═CH₂, —OCH₂C(CH₃)═CH₂, and
      —C(CH₃)═CH₂;
      L comprises at least one of a bond, —CH₂OC(═O)—, —CH₂OC(═O)NHCH₂CH₂OC(═O)—, and —C(═O)NHCH₂CH₂OC(═O)—;
      R is a monovalent perfluoro polyether alkyl group; and
      R¹ is a divalent perfluoro polyether alkylene group

In another aspect, a composition comprising a reacted functionalized oligomer, the composition comprising:
a highly fluorinated polymer having a plurality of segments, the segments comprising at least one of:
   R-L-CHYCH₂—CF₂—,
   R-L-CH₂CHYCH₂—CF₂—,
   R-L-OCHYCH₂—CF₂—,
   R-L-OCH₂CHYCH₂—CF₂—,
   R-L-OCH₂C(CH₃)YCH₂—CF₂—,
   R-L-C(CH₃)YCH₂—CF₂—, and
   R-L-OCFYCF₂—CF₂—,
   where Y is —I or —Br;
   n is 1 or 2;
   L comprises at least one of a bond, —CH₂OC(═O)—, —CH₂OC(═O)NHCH₂CH₂OC(═O)—, and —C(═O)NHCH₂CH₂OC(═O)—; and
   R is a monovalent perfluoro polyether alkyl group;
   wherein the segment has a number average molecular weight of 1000-16,000 g/mol.

In another aspect, composition comprising a reacted functionalized oligomer, the composition comprising:

a highly fluorinated polymer having a plurality of segments, the segments comprising at least one of:
R¹-(L-CHYCH₂—CF₂—)₂,
R¹-(L-CH₂CHYCH₂—CF₂—)₂,
R¹-(L-OCHYCH₂—CF₂—)₂,
R¹-(L-OCH₂CHYCH₂—CF₂—)₂,
R¹-(L-OCH₂C(CH₃)YCH₂—CF₂—)₂, and
R¹-(L-C(CH₃)YCH₂—CF₂—)₂
where Y is —I or —Br;
n is 1 or 2
   L comprises at least one of a bond, —CH₂OC(═O)—, —CH₂OC(═O)NHCH₂CH₂OC(═O)—, and —C(═O)NHCH₂CH₂OC(═O)—; and
   R¹ is a divalent perfluoro polyether alkylene group.

In another aspect, a method of making a cured fluoropolymer is described. The method comprising:
(a) contacting a curable highly fluorinated polymer comprising at least one of an iodine cure-site, a bromine cure-site, and a nitrile cure-site and 4 to 25 parts of a curable oligomer per 100 parts of the curable highly fluorinated polymer with a peroxide curative to form a mixture, wherein the curable oligomer is
   (i) a monofunctional compound of formula (I) R-L-X having a number average molecular weight of 1000-16,000 g/mol,
   (ii) a difunctional compound of formula (II) is R¹-(L-X¹)₂ having a number average molecular weight of 1000-6000 g/mol, or
   (iii) mixtures thereof,

### Where:

X comprises at least one of:
—CH═CH₂, —CH₂CH═CH₂, —OCH═CH₂, —OCH₂CH═CH₂, —OCH₂C(CH₃)═CH₂,
—C(CH₃)═CH₂, and —OCF═CF₂;
X¹ comprises at least one of:
—CH═CH₂, —CH₂CH═CH₂, —OCH═CH₂, —OCH₂CH═CH₂, —OCH₂C(CH₃)═CH₂,
and —C(CH₃)═CH₂;
L comprises at least one of a bond, —CH₂OC(═O)—, —CH₂OC(═O)NHCH₂CH₂OC(═O)—, and —C(═O)NHCH₂CH₂OC(═O)—;
R is a monovalent perfluoro polyether alkyl group; and
R¹ is a divalent perfluoro polyether alkylene group; and
(b) exposing the mixture to heat.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer, excluding the sites of polymer initiation and termination;

“crosslinking” refers to connecting two pre-formed polymer chains using chemical bonds or chemical groups;

“cure site” refers to functional groups, which may participate in crosslinking;

“interpolymerized” refers to monomers that are polymerized together to form a polymer backbone;

“monomer” is a molecule which can undergo polymerization which then form part of the essential structure of a polymer;

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms; and

“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprising at least one of” or “comprises at least one of” A, B, and C refers to element A by itself, element B by itself, element C by itself, A and B, A and C, B and C, and a combination of all three.

Plasticizing agents are added to polymer compositions to decrease cost. For example, plasticizing agents decrease the viscosity of the polymer composition, improving the processability of the polymer, which leads to reduced manufacturing costs and/or allowing other modes of process manufacturing (for example, a composition that is compression molded could be extrusion or injection molded). Cheaper materials, like fillers, can be added to the polymer composition to decrease cost, however, fillers can increase the viscosity of the material. Thus, plasticizers can be used to offset this viscosity increase, making the polymer composition easier to process.

Plasticizers can be classified as an internal plasticizer or an external plasticizer. An internal plasticizer comprises a reactive functionality, enabling the plasticizer to become part of the cured polymer network. An external plasticizer is not reactive with the polymer network and can “bloom” to the surface of the cured polymer and potentially leach from the cured polymer.

Perfluoropolymers exhibit outstanding high temperature tolerance and chemical resistance in both the cured and uncured states. These properties are attributable to the stability and inertness of the copolymerized perfluorinated monomer units (such as tetrafluoroethylene, hexafluoropropylene, perfluoro(methyl vinyl)ether, or perfluoro(propyl vinyl)ether), which form the major portion (e.g., at least 50, 60, 70, 80, 85, 90, or even 95%) of the polymer backbone. However, the inertness of copolymerized perfluorinated monomer units can lead to compatibility issues (such as immiscibility) with non-fluorinated plasticizers.

In the present disclosure, it has been found that curable oligomers such as those disclosed herein can be used in peroxide curable highly fluorinated polymer compositions to aid processing. The compounded fluoropolymers comprising the curable oligomers disclosed herein, can have improved processability as shown by a lower viscosity. In one embodiment, the fluoropolymer when cured, may demonstrate improved physical properties such as increased elongation, without substantially compromising other properties such as tensile, compression set, etc.

Curable Oligomer

The curable oligomers disclosed herein can be used as plasticizing agents for a curable highly fluorinated polymer.

The curable oligomer can be (a) a monofunctional compound of formula (I), a difunctional compound of formula (II), and (c) mixtures thereof.

The monofunctional compound of formula (I) corresponds to:

R-L-X

wherein
X comprises at least one of the following functional groups: —CH═CH₂, —CH₂CH═CH₂, —OCH═CH₂, —OCH₂CH═CH₂, —OCH₂C(CH₃)═CH₂, —C(CH₃)═CH₂, and —OCF═CF₂;
L comprises at least one of the following: a bond, —CH₂OC(═O)—, —CH₂OC(═O)NHCH₂CH₂OC(═O)—, and —C(═O)NHCH₂CH₂OC(═O)—; and
R is a monovalent perfluoro polyether alkyl group.

In one embodiment, R is a monovalent perfluoro polyether alkyl group comprising at least 3, 4, 5, and even 6 ether linkages (i.e., —O—) and at most 50, 80, 100, 150, and even 200 ether linkages.

In one embodiment, R is a monovalent perfluoro polyether alkyl group comprising at least 12, 15, and even 20 carbon atoms; and at most 100, 200, 300, and even 400 carbon atoms.

Exemplary R groups include:

CF₃CF₂CF₂O[CF(CF₃)CF₂O]ₘ—CF(CF₃)— where m is an integer of at least 5, 10, or even 15; and at most 30, 40, 50, 75, or even 100;
CF₃O[CF₂CF₂O]ₙ—CF₂— where n is an integer of at least 8, 10 or even 12; and at most 50, 75, or even 100;
CF₃CF₂O[(CF₂CF₂O)ₚ(CF₂O)_{q}]—CF₂— wherein [(CF₂CF₂O)ₚ(CF₂O)_{q}] represents a unit comprising the random ordering of at least five (CF₂CF₂O) units and at least five (CF₂O) units and the sum of p+q is an integer of at least 10, 12, or 15; and at most 25, 30, 35, or even 40;
CF₃CF₂CF₂CF₂O[CF₂CF₂CF₂CF₂O]ₛ—CF₂CF₂CF₂— where s is an integer of at least 3, 5, 8, or even 10; and at most 50, 75, or even 100; and
CF₃CF₂CF₂O[CF₂CF₂CF₂O]ₜ—CF₂CF₂— where t is an integer of at least 8, 10 or even 12; and at most 50, 75, or even 100.

The monofunctional compound of formula (I) has a number average molecular weight of at least 1000, 1500, 2000, 2500, 3000, or even 4000 grams/mole; and at most 6000, 8000, 10 000, 12 000, 14 000, or even 16 000 grams per mole. The number average molecular weight (Mn) can be determined by standard techniques known in the art, such as by H¹ and/or F¹⁹ nuclear magnetic resonance (NMR).

Exemplary compounds according to formula (I) include:

### R—CF═CF₂

### R—CH═CH₂

R—CH₂OCH₂CH═CH₂
R—CF₂OCH₂CH═CH₂
R—CH₂OC(═O)CH═CH₂
R—CH₂OC(═O)C(CH₃)═CH₂
R—CH₂—O—C(═O)NH—CH₂CH₂—O—C(═O)CH═CH₂
R—CH₂—O—C(═O)NH—CH₂CH₂—O—C(═O)C(CH₃)═CH₂
R—C(═O)NH—CH₂CH₂OC(═O)CH═CH₂; and
R—C(═O)NH—CH₂CH₂OC(═O)C(CH₃)═CH₂
where R is defined as above.

Exemplary compounds according to formula (I) include:

CF₃CF₂CF₂O—(CF(CF₃)CF₂O)ₙ—CF(CF₃)—CH═CH₂
CF₃CF₂CF₂O—(CF(CF₃)CF₂O)ₙ—CF(CF₃)—CH₂OCH₂CH═CH₂
CF₃CF₂CF₂O—(CF(CF₃)CF₂O)ₙ—CF(CF₃)—CF₂OCH₂CH═CH₂
CF₃CF₂CF₂O—(CF(CF₃)CF₂O)ₙ—CF(CF₃)—CH₂OC(═O)CH═CH₂
CF₃CF₂CF₂O—(CF(CF₃)CF₂O)ₙ—CF(CF₃)—CH₂OC(═O)C(CH₃)═CH₂
CF₃CF₂CF₂O—(CF(CF₃)CF₂O)ₙ—CF(CF₃)—CH₂OC(═O)NHCH₂CH₂OC(═O)C(CH₃)═CH₂
CF₃CF₂CF₂O—(CF(CF₃)CF₂O)ₙ—CF(CF₃)—C(═O)NHCH₂CH₂OC(═O)CH═CH₂ and
CF₃CF₂CF₂O—(CF(CF₃)CF₂O)ₙ—CF(CF₃)—C(═O)NHCH₂CH₂OC(═O)C(CH₃)═CH₂, wherein n is an integer from at least 5, 10, or even 15 and at most 30, 40, 50, 75, or even 100.

Such compounds can be obtainable by converting a perfluoropolyether acid to the desired functional group by known organic synthetic methods, i.e., a perfluoropolyether acid is esterified with methanol and acid then reacted with ethanolamine to make the perfluoropolyether amidol followed by acryloyl chloride to provide an acrylate functional group.

The difunctional compound of formula (II) corresponds to:

R¹-(L-X¹)₂

wherein
X¹ comprises at least one of the following functional groups: —CH═CH₂, —CH₂CH═CH₂, —OCH═CH₂, —OCH₂CH═CH₂, —OCH₂C(CH₃)═CH₂, and —C(CH₃)═CH₂;
L comprises at least one of the following: a bond, —CH₂OC(═O)—, —CH₂OC(═O)NHCH₂CH₂OC(═O)—, and —C(═O)NH—CH₂CH₂OC(═O)—; and
R¹ is a divalent perfluoro polyether alkylene group;

In one embodiment, R¹ is a divalent perfluoro polyether alkylene group comprising at least 4, 5, and even 6 ether linkages and at most 20, 30, 40, and even 50 ether linkages.

In one embodiment, R¹ is a divalent perfluoro polyether alkylene group comprising at least 12, 15, and even 20 carbon atoms; and at most 50, 75, and even 100 carbon atoms.

Exemplary R¹ groups include:

—CF(CF₃)—[OCF₂CF(CF₃)]ᵤ—O—(CF₂)ᵥ—O[CF(CF₃)CF₂—O]_{w}—CF(CF₃)— where u is an integer of at least 2, 3, 4, or even 5, and at most 10, 20, 30, 40, or even 50; v is an integer of at least 2, 3, or 4, and at most 10, 20, 30, 40, or even 50; and w is an integer of at least 2, 3, 4, or even 5, and at most 10, 20, 30, 40, or even 50;
—CF₂O[CF₂CF₂O]r-CF₂— where n is an integer of at least 8, 10, or even 12; and at most 20, 30, 40, or even 50;
—CF₂O[(CF₂CF₂O)ₚ(CF₂O)_{q}]—CF₂— wherein [(CF₂CF₂O)ₚ(CF₂O)_{q}] represents a unit comprising the random ordering of at least five (CF₂CF₂O) units and at least five (CF₂O) units and the sum of p+q is an integer of at least 10, 12, or 15; and at most 25, 30, 35, or even 40;
—CF₂CF₂CF₂O[CF₂CF₂CF₂CF₂O]s-CF₂CF₂CF₂— where s is an integer of at least 3, 4, 5, 6, 8, or even 10; and at most 50, 75, or even 100; and
—CF₂CF₂O[CF₂CF₂CF₂O]ₜ—CF₂CF₂— where t is an integer of at least 5, 6, 8, or even 10; and at most 50, 75, or even 100.

The difunctional compound of formula (II) has a number average molecular weight of at least 1000, 1500, 2000, or even 2500 grams/mole; and at most 4000, 4500, 5000, 5500, or even 6000 grams per mole.

Exemplary compounds according to formula (II) include:

R¹—(CH═CH₂)₂
R¹—(CH₂OCH₂CH═CH₂)₂
R¹—(CF₂OCH₂CH═CH₂)₂
R¹—(CH₂OC(═O)CH═CH₂)₂
R¹—(CH₂OC(═O)C(CH₃)═CH₂)₂
R¹—(CH₂—O—C(═O)NH—CH₂CH₂—O—C(═O)CH═CH₂)₂
R¹—(CH₂—O—C(═O)NH—CH₂CH₂—O—C(═O)C(CH₃)═CH₂)₂
R¹—(C(═O)NH—CH₂CH₂OC(═O)CH═CH₂)₂; and
R¹—(C(═O)NH—CH₂CH₂OC(═O)C(CH₃)═CH₂)₂
where R¹ is defined as above.

Exemplary compound according to formula (II) include:

CH₂═CHC(═O)OCH₂—CF(CF₃)[OCF₂CF(CF₃]ᵤ—O—(CF₂)ᵥ—O[CF(CF₃)CF₂O]_{w}—CF(CF₃)—CH₂OC(═O)CH═CH₂; and
CH₂═CHC(═O)OCH₂—CF₂O[(CF₂CF₂O)ₚCF₂O)_{q}]CF₂—CH₂OC(═O)CH═CH₂;
where u is an integer of at least 2 and at most 50; v is an integer of at least 2 and at most 50, w is an integer of at least 2 and at most 50, wherein [(CF₂CF₂O)ₚ(CF₂O)_{q}] is a random unit comprising at least five (CF₂CF₂O) units and at least five (CF₂O) units and the sum of p+q is an integer of at least 10, 15, or even 20 and at most 30, 35, or even 40.

Such compounds of formula (II) can be made by converting a perfluoropolyether diacid to the desired difunctional group by known organic synthetic methods, for example, a perfluoropolyether diacid is esterified with methanol and acid then reacted with ethanolamine to make the perfluoropolyether diamidol followed by acryloyl chloride to provide diacrylate functionality.

Highly Fluorinated Polymer

The highly fluorinated polymers disclosed herein are peroxide curable meaning that curing occurs via a peroxide initiated free radical reaction, as opposed to another type of reaction such as a reaction initiated by electromagnetic radiation (e.g., ultraviolet light).

The curable fluoropolymers of the present disclosure are at least highly fluorinated polymers, meaning that backbone of the polymer is either perfluorinated (comprising C—F bonds and no C—H bond) or highly fluorinated (comprising at least one C—H bond, but having less than 3, 2, 1, 0.5, or even 0.25% by weight of hydrogen along the polymer backbone).

The curable fluoropolymer is derived from a perfluorinated monomer. Exemplary perfluorinated monomers include: tetrafluoroethylene (TFE), hexafluoropropylene (HFP), trifluorochloroethylene (CTFE), perfluorovinyl ethers (including perfluoroallyl vinyl ethers and perfluoroalkoxy vinyl ethers), perfluoroallyl ethers (including perfluoroalkyl allyl ethers and perfluoroalkoxy allyl ethers), perfluoroalkyl vinyl monomers, fluorinated bisolefin monomers, and combinations thereof.

Suitable perfluoroalkyl vinyl monomers correspond to the general formula: CF₂═CF—R^{d}_{f} wherein Rad represents a perfluoroalkyl group of 1-10, or even 1-5 carbon atoms.

Examples of perfluorovinyl ethers that can be used in the present disclosure include those that correspond to the formula: CF₂═CF—O—R_{f} wherein R_{f} represents a perfluorinated aliphatic group that may contain no, or one or more ether linkages and up to 12, 10, 8, 6 or even 4 carbon atoms. Exemplary perfluorinated vinyl ethers correspond to the formula: CF₂═CFO(R^{a}_{f}O)ₙ (R^{b}_{f}O)ₘR^{c}_{f} wherein R^{a}_{f} and R^{b}_{f} are different linear or branched perfluoroalkylene groups of 1-6 carbon atoms, in particular 2-6 carbon atoms, m and n are independently 0-10 and R^{c}_{f} is a perfluoroalkyl group of 1-6 carbon atoms. Specific examples of perfluorinated vinyl ethers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, CF₃—(CF₂)₂—O—CF(CF₃)—CF₂—O—CF(CF₃)—CF₂—O—CF═CF₂, and perfluoro-methoxy-methylvinylether (CF₃—O—CF₂—O—CF═CF₂), and mixtures thereof.

Examples of perfluoroallyl ethers that can be used in the present disclosure include those that correspond to the formula: CF₂═CFCF₂—O—R_{f} wherein R_{f} represents a perfluorinated aliphatic group that may contain no, or one or more ether linkages and up to 10, 8, 6 or even 4 carbon atoms. Specific examples of perfluorinated allyl ethers include: CF₂═CF—CF₂—O—(CF₂)ₙF wherein n is an integer from 1 to 5, and

CF₂═CF₂—CF₂—O—(CF₂)ₓ—O—(CF₂)_{y}—F wherein x is an integer from 2 to 5 and y is an integer from 1 to 5. Specific examples of perfluorinated allyl ethers include: perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, and mixtures thereof.

In one embodiment, the highly fluorinated polymer comprises at least 20, 30, 40 and even 50 wt % and at most 60, or even 65 wt % of a perfluorovinyl ether monomer and/or perfluoroallyl ether monomer versus total monomer in the highly fluorinated polymer.

Suitable fluorinated bisolefin monomers, include perfluorinated and partially fluorinated bisolefin monomers corresponding to the general formula

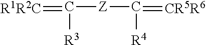

wherein R¹, R², R³, R⁴, R⁵, and R⁶ are independently H, F, or a C1-C5 perfluorinated alkyl group; and Z is a perfluoroalkylene or perfluorocycloalkylene radical, which is linear or branched, optionally containing at least one ether linkage. In one embodiment, R₁, R₂, R₃, and R₄ are, independently from each other, F, CF₃, C₂F₅, C₃F₇, C₄F₉, or H. In one embodiment, Z comprises at least 1, 2, 3, 4, or even 5 carbon atoms and at most 8, 10, 12, 16, or even 18 carbon atoms. In one embodiment, Z is —O—Rf₁—O—; —CF₂—O—Rf₁—O—CF₂—; or CF₂—O—Rf₁—O—, wherein Rf₁ represents a residue selected from linear or branched perfluoroalkanediyl, perfluorooxaalkanediyl or perfluoropolyoxaalkanediyl residues or a perfluorinated arylene residue. The arylene may be non-substituted or substituted with one or more halogen atoms other than F, perfluorinated alkyl residues, perfluorinated alkoxy residues, perfluorinated oxaalkyl residues, perfluorinated polyoxaalkyl residues, perfluorinated phenyl or phenoxy moieties or combinations thereof, wherein the phenyl or phenoxy residues may be non-substituted or substituted with one or more perfluorinated alkyl, alkoxy, oxaalkyl or polyoxaalkyl residue or one or more halogen atoms other than F or combinations thereof. In one embodiment, the arylene residue contains at least 1, 2, 3, 4, or even 5 carbon atoms; and at most 10, 12, or even 14 carbon atoms.

Exemplary bisolefin monomers include: CH₂═CH(CF₂)₄CH═CH₂, CH₂═CH(CF₂)₆CH═CH₂, CH₂═CH(CF₂)₈CH═CH₂, CF₂═CF—O—(CF₂)₂—O—CF═CF₂, CF₂═CF—O—(CF₂)₃—O—CF═CF₂, CF₂═CF—O—(CF₂)₄—O—CF═CF₂, CF₂═CF—O—(CF₂)₅—O—CF═CF₂, CF₂═CF—O—(CF₂)₆—O—CF═CF₂, CF₂═CF—CF₂—O—(CF₂)₂—O—CF═CF₂, CF₂═CF—CF₂—O—(CF₂)₃—O—CF═CF₂, CF₂═CF—CF₂—O—(CF₂)₄—O—CF═CF₂, CF₂═CF—CF₂—O—(CF₂)₄—O—CF═CF₂, CF₂═CF—CF₂—O—(CF₂)₅—O—CF═CF₂, CF₂═CF—CF₂—O—(CF₂)₆—O—CF═CF₂, CF₂═CF—CF₂—O—(CF₂)₂—O—CF₂—CF═CF₂, CF₂═CF—CF₂—O—(CF₂)₃—O—CF₂—CF═CF₂, CF₂═CF—CF₂—O—(CF₂)₄—O—CF₂—CF═CF₂, CF₂═CF—CF₂—O—(CF₂)₅—O—CF₂—CF═CF₂, CF₂═CF—CF₂—O—(CF₂)₆—O—CF₂—CF═CF₂, CF₂═CF—O—CF₂CF₂—CH═CH₂, CF₂═CF—(OCF(CF₃)CF₂)—O—CF₂CF₂—CH═CH₂, CF₂═CF—(OCF(CF₃)CF₂)₂—O—CF₂CF₂—CH═CH₂, CF₂═CF CF₂—O—CF₂CF₂—CH═CH₂, CF₂═CF CF₂—(OCF(CF₃)CF₂)—O—CF₂CF₂—CH═CH₂, CF₂═CFCF₂—(OCF(CF₃)CF₂)₂—O—CF₂CF₂—CH═CH₂, CF₂═CF—CF₂—CH═CH₂, CF₂═CF—O—(CF₂), —O—CF₂—CF₂—CH═CH₂ wherein c is an integer selected from 2 to 6, CF₂═CFCF₂—O—(CF₂), —O—CF₂—CF₂—CH═CH₂ wherein c is an integer selected from 2 to 6, CF₂═CF—(OCF(CF₃)CF₂)_{b}—O—CF(CF₃)—CH═CH₂ wherein b is 0, 1, or 2, CF₂═CF—CF₂—(OCF(CF₃)CF₂)_{b}—O—CF(CF₃)—CH═CH₂ wherein b is 0, 1, or 2, CH₂═CH—(CF₂)ₙ—O—CH═CH₂ wherein n is an integer from 1-10, and CF₂═CF—(CF₂)ₐ—(O—CF(CF₃)CF₂)_{b}—O—(CF₂)_{c}—(OCF(CF₃)CF₂)_{f}—O—CF═CF₂ wherein a is 0 or 1, b is 0, 1, or 2, c is 1, 2, 3, 4, 5, or 6, and f is 0, 1, or 2. In one embodiment, the highly fluorinated polymer comprises less than 10, 5, or even less than 1 mol % of a fluorinated bisolefin monomer based on the total moles of monomer incorporated into the fluoropolymer.

In one embodiment, the highly fluorinated polymer is not derived from vinylidene fluoride, vinyl fluoride, or a hydrocarbon monomer (such as ethylene or propylene). In one embodiment, the highly fluorinated polymer does not comprise any silicon atoms, such as siloxane groups.

The curable highly fluorinated polymer further comprises a cure-site, wherein the cure-site comprises iodine, bromine, nitrile, of combinations thereof. In the present disclosure, the highly fluorinated polymer may be polymerized in the presence of a chain transfer agent and/or cure site monomers to introduce cure-sites into the highly fluorinated polymer.

In one embodiment, the highly fluorinated polymer is polymerized in the presence of a bromine and/or iodine-containing chain transfer agent, as is known in the art. For example, suitable iodo-chain transfer agent in the polymerization include the formula of RIₓ, where (i) R is a perfluoroalkyl or chloroperfluoroalkyl group having 3 to 12 carbon atoms; and (ii) x=1 or 2. The iodo-chain transfer agent may be a perfluorinated iodo-compound. Exemplary iodo-perfluoro-compounds include 1,3-diiodoperfluoropropane, 1,4-diiodoperfluorobutane, 1, 6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutan, and mixtures thereof. In some embodiments, the bromine is derived from a brominated chain transfer agent of the formula: RBrₓ, where (i) R is a perfluoroalkyl or chloroperfluoroalkyl group having 3 to 12 carbon atoms; and (ii) x=1 or 2. The chain transfer agent may be a perfluorinated bromo-compound. Exemplary bromo-perfluoro-compounds include CF₂Br₂, Br(CF₂)₂Br, Br(CF₂)₄Br, CF₂ClBr, CF₃CFBrCF₂Br, and mixtures thereof.

Cure-site monomers, if used, comprise at least one of the following: bromine, iodine, and nitrile cure moiety.

In one embodiment, the cure site monomers may be derived from one or more compounds of the formula: a) CY₂═CY(Z), wherein: (i) each Y is independently H or F; and (ii) Z is I, Br, R_{f}—U wherein U=I or Br and R_{f}=a perfluorinated or partially perfluorinated alkylene group optionally containing O atoms or (b) Y(CF₂)_{q}Y, wherein: (i) Y is Br or I or Cl and (ii) q=1-6. In addition, non-fluorinated bromo- or iodo-olefins, e.g., vinyl iodide and allyl iodide, can be used. In some embodiments, the cure site monomers are derived from one or more compounds selected from the group consisting of CH₂═CHI, CF₂═CHI, CF₂═CFI, CH₂═CHCH₂I, CF₂═CFCF₂I, ICF₂CF₂CF₂CF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, CF₂═CFCF₂Cl, and combinations thereof.

In another embodiment, the cure site monomers comprise nitrile-containing cure moieties. Useful nitrile-containing cure site monomers include nitrile-containing fluorinated olefins and nitrile-containing fluorinated vinyl ethers, such as: perfluoro(8-cyano-5-methyl-3,6-dioxa-1-octene); CF₂═CFO(CF₂)_{z}CN wherein z is an integer from 2 to 12;

CF₂═CFO(CF₂)ᵤOCF(CF₃)CN wherein u is an integer from 2 to 6;
CF₂═CFO[CF₂CF(CF₃)O]_{q}(CF₂O)_{y}CF(CF₃)CN or CF₂═CFO[CF₂CF(CF₃)O]_{q}(CF₂)_{y}OCF(CF₃)CN wherein q is an integer from 0 to 4 and y is an integer from 0 to 6; or
CF₂═CF[OCF₂CF(CF₃)]ᵣO(CF₂)ₜCN wherein r is 1 or 2, and t is an integer from 1 to 4; and derivatives and combinations of the foregoing. Examples of a nitrile-containing cure site monomer include CF₂═CFO(CF₂)₅CN, CF₂═CFOCF₂CF(CF₃)OCF₂CF₂CN, CF₂═CFOCF₂CF(CF₃)OCF₂CF(CF₃)CN, CF₂═CFOCF₂CF₂CF₂OCF(CF₃)CN, CF₂═CFOCF₂CF(CF₃)OCF₂CF₂CN; and combinations thereof.

In one embodiment, the curable highly fluorinated polymer is derived from a fluorinated di-iodo ether compound of the following formula:

R_{f}CF(I)—(CX₂)ₙ—(CX₂CXR)ₘ—O—R″_{f}—Oₖ—(CXR′CX₂)ₚ—(CX₂)_{q}—CF(I)—R′_{f}

wherein

X is independently selected from F, H, and Cl;

k is 0 or 1;

n, m, q, and p are independently selected from an integer from 0-5, with the proviso that when k is 0, n+m is at least 1 and p+q is at least 1. R_{f} and R′_{f} are independently selected from F and a monovalent perfluoroalkane having 1-3 carbons;

R is F, or a partially fluorinated or perfluorinated alkane comprising 1-3 carbons; and

R″_{f} is a divalent fluoroalkylene having 1-5 carbons or a divalent fluorinated alkylene ether having 1-8 carbons and at least one ether linkage.

Exemplary R″_{f} segments include: —CF₂—; —CF₂—CF₂—; —CF₂—CF₂—CF₂—; —(CF₂)ₙ— wherein n is an integer from 1-5; —CFH—; —CFH—CF₂—; —CH₂—CF₂—; —CF₂—CF(CF₃)—; —CH₂—CF₂—CF₂—;
—CF₂—CHF—CF₂—; —CF₂—CH₂—CF₂—; —CF₂—(OCF₂)ₙ— wherein n is an integer from 0-5;
—CF₂—(OCF₂)ₙ—OCF₂— wherein n is an integer from 0-5; —CF₂—(O—[CF₂]ₙ)_{z}— wherein n is an integer from 0-5, and z is an integer from 1-4; —CF₂—(O—[CF₂]ₙ)—CF₂— where n is 0-5;
—(CF₂—CF)ₙ— wherein n is an integer from 0-3; —CX₁X₂—(O—[CFX₃])ₙ—CX₄′X₅— wherein n is 0-5 and X₁, X₂, X₃, X₄, and X₅ are independently selected from H, F, or Cl;
—(CF₂)ₙ—(OCF₂—CF(CF₃))ₚ—O—(CF₂)_{z} wherein n is an integer from 1-5, p is an integer from 0-5 and z is an integer from 1-5; and
—[OCF₂—CF(CF₃)]ₘ—O—(CF₂)ₙ—O—[CF(CF₃)CF₂O]ₚ—(CF₂)_{z} where p and m are independently selected from an integer from 1-20, n is an integer from 2-8; and z is an integer from 1-5.
Exemplary fluorinated di-iodo ether compounds include:
I—CF₂—CF₂—O—CF₂—CF₂—I; I—CF₂—CF₂—O—(CF₂)_{b}—I wherein b is an integer from 3-10;
I—(CF₂)_{c}—O—(CF₂)_{b}—I wherein c is an integer from 3-10 and b is an integer from 3-10; ICF₂—CF₂—O—CF₂—O—CF₂—CF₂—I;
ICF₂—CF₂—O—CF₂—(CF₂)_{b}—O—CF₂—CF₂I wherein b is an integer from 1-5;
ICF₂—CF₂—[O—CF₂—(CF₂)_{b}]z-O—CF₂—CF₂I wherein b is an integer from 1-5, z is an integer from 1-4;
I—CF₂—CH₂—O—CF₂—CF₂—CF₂I; I—CF₂—CH₂—CF₂—O—CF₂—CF₂—CF₂I;
I—CF₂—CHF—CF₂—O—CF₂—CF₂—CF₂I; ICF₂—CF₂—O—CF₂—CFI—CF₃;
ICF₂—CF₂—(CF₂)ₐ—[O—CF₂—CF₂]b-(0-[CF₂]_{c})_{z}—O[—CF₂]ₐ—CF₂—CF₂I wherein a is an integer from 0-6, b is an integer from 0-5, c, is an integer from 1-6, d is an integer from 0-6 and z is an integer from 0-6;
ICF₂—(CF₂)ₐ [O—CF₂CF(CF₃)]_{b}—O—(CF₂)_{c}—O—[CF(CF₃)CF₂O]_{d}—(CF₂)_{z}—O—CF₂CF₂—I wherein a is an integer from 0-6, b is an integer from 0-5, c, is an integer from 1-6, d is an integer from 0-5 and z is an integer from 0-5; and I—CF₂—(CF₂)ₐ—O—(CF₂)_{b}—O—CF₂—CF(CF₃)—I wherein a is an integer from 1-5 and b is an integer from 1-5. Polymers derived from these fluorinated di-iodo ether compounds are described in U.S. Pat. No. 9,982,091 (Hintzer et al.), herein incorporated by reference.

In one embodiment, the curable highly fluorinated polymer is derived from TFE, a perfluorinated ether monomer and an iodinated cure site monomer. Such polymers are disclosed in U.S. Pat. Publ. No. 2016-0280824 (Hintzer et al.), herein incorporated by reference. In some embodiments, the curable fluoropolymer comprises at least 30, 40, 60, 62, and even 65 mol % of TFE is used and no more than 70, 75, or even 80 mol % of TFE based on the total moles of monomer incorporated into the curable highly fluorinated polymer. In some embodiments, the curable highly fluorinated polymer comprises at least 36, 37, 38, 39, and even 40 mol % and less than 49, 48, 47, 46, or even 45 mol % of a perfluoro ether monomer based on the total moles of monomer incorporated into the fluoropolymer, wherein the perfluoro ether monomer is CF₂═CF(CF₂)_{b}O(R_{f″}O)ₙ(R_{f}O)ₘR_{f} where R_{f″} and R_{f′} are independently linear or branched perfluoroalkylene radical groups of 2-6 carbon atoms, m and n are independently an integer from 0 to 10 and R_{f} is a perfluoroalkyl group of 1-6 carbon atoms, b=0 or 1. Exemplary perfluorovinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂, perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, and combinations thereof. In some embodiments, the curable highly fluorinated polymer comprises at least 0.02, 0.05, and even 0.1 mol % and at most 0.5, 0.75, or even 0.9 mol % of an iodinated cure site monomer based on the total moles of monomer incorporated into the curable fluoropolymer. The iodinated cure site monomer is

CF₂═CF—(CF₂)_{g}—(O—CF(CF₃)—CF₂)ₕ—O—(CF₂)ᵢ—(O)ⱼ—(CF₂)ₖ—CF(I)—X

wherein X is selected from F or CF₃; g is 0 or 1; h is an integer selected from 0-3; i is an integer selected from 0, 1, 2, 3, 4, or 5; j is an integer selected from 0 or 1; and k is an integer selected from 0, 1, 2, 3, 4, 5 or 6. Exemplary iodinated cure site monomer include: CF₂═CFOC₄F₈I (MV4I), CF₂═CFOC₂F₄I, CF₂═CFOCF₂CF(CF₃)OC₂F₄I, CF₂═CF—(OCF₂CF(CF₃))₂—O—C₂F₄I, CF₂═CF—O—CF₂CFI—CF₃, CF₂═CF—O—CF₂CF(CF₃)—O—CF₂CFI—CF₃, CF₂═CF—O—(CF₂)₂—O—C₂F₄I, CF₂═CF—O—(CF₂)₃—O—C₂F₄I, CF₂═CF—O—(CF₂)₄—O—C₂F₄I, CF₂═CF—O—(CF₂)₅—O—C₂F₄I, CF₂═CF—O—(CF₂)₆—O—C₂F₄I, CF₂═CF—CF₂—O—CF₂—O—C₂F₄I, CF₂═CF—CF₂—O—(CF₂)₂—O—C₂F₄I, CF₂═CF—CF₂—O—(CF₂)₃—O—C₂F₄I, CF₂═CF—CF₂—O—(CF₂)₄—O—C₂F₄I, CF₂═CF—CF₂—O—(CF₂)₅—O—C₂F₄I, CF₂═CF—CF₂—O—(CF₂)₆—O—C₂F₄I, CF₂═CF—CF₂—O—C₄F₈I, CF₂═CF—CF₂—O—C₂F₄I, CF₂═CF—CF₂—O—CF₂CF(CF₃)—O—C₂F₄I, CF₂═CF—CF₂—(OCF₂CF(CF₃))₂—O—C₂F₄I, CF₂═CF—CF₂—O—CF₂CFI—CF₃, CF₂═CF—CF₂—O—CF₂CF(CF₃)—O—CF₂CFI—CF₃, and combinations thereof.

In one embodiment, the curable highly fluorinated polymer is derived from TFE, a perfluorinated ether monomer, and a brominated cure site monomer. In some embodiments, the curable fluoropolymer comprises at least 40, 50, 60, and even 65 wt % of TFE is used and no more than 70, 75, or even 80 wt % of TFE based on the total moles of monomer incorporated into the curable highly fluorinated polymer. In some embodiments, the curable highly fluorinated polymer comprises at least 30, 40, 50, and even 60 wt % and less than 60, 50, 40, 30, or even 20 wt % of a perfluoro ether monomer based on the total moles of monomer incorporated into the highly fluorinated polymer, wherein the perfluoro ether monomer is CF₂═CF(CF₂)_{b}O(R_{f″}O)ₙ(R_{f}O)ₘR_{f} where R_{f}r and R_{f} are independently linear or branched perfluoroalkylene radical groups of 2-6 carbon atoms, m and n are independently an integer from 0 to 10 and R_{f} is a perfluoroalkyl group of 1-6 carbon atoms, b=0 or 1. In some embodiments, the curable highly fluorinated polymer comprises at least 0.5, 1, and even 2 wt % to at most 4, 5 or even 10 wt % of a bromine-cure site monomer as described above, such as bromotrifluoroethylene, 1-bromo-2,2-difluoroethylene, and/or 4-bromo-3,3,4,4-tetrafluorobutene-1.

In one embodiment, the curable fluoropolymer is an amorphous polymer, meaning that it does not comprise a distinct melting point.

Curable Composition

The compositions of the present disclosure comprise the curable highly fluorinated polymer and the curable oligomer disclosed herein. The present disclosure has discovered a particular range of curable oligomer, wherein a sufficient amount is added to cause processing improvements, but not too much which can compromise the resulting physical properties of the cured highly fluorinated polymer such as tensile, elongation, and/or compression set (for example, doubling the compression set). In one embodiment, the curable oligomer is used from at least 4, 6, or even 8 parts (by weight); and at most 10, 15, 20, or even 25 parts (by weight) per 100 parts of the curable highly fluorinated polymer.

Because the curable oligomer has a reactive site, it can be cured into the fluoropolymer and resists leeching out and/or blooming to the surface of the cured article.

The curable oligomers disclosed herein may be used to reduce the modulus (or soften) of the polymer composition. In one embodiment, the curable highly fluorinated polymer has a modulus at 100° C. of at least 10, 20, 30, 50, or even 60; and no more 200, 300, or even 400 kPa. Because the modulus can vary based on the composition of the fluoropolymer, in one embodiment, the curable oligomer reduces the modulus at 100° C. of the curable highly fluorinated polymer composition, by at least 10, 20, or even 30% as compared to an identical composition not comprising the curable oligomer disclosed herein.

In addition to the curable highly fluorinated polymer and the curable oligomer, the curable compositions disclosed herein may further comprise a free radical source, used to initiate the cure. Such free radical sources include organic or inorganic peroxides. Organic peroxides are preferred, particularly those that do not decompose during dynamic mixing temperatures.

Examples of the organic peroxide include benzoyl peroxide, dicumyl peroxide, di-tert-butyl peroxide, 2,5-di-methyl-2,5-di-tert-butylperoxyhexane, 2,4-dichlorobenzoyl peroxide, 1,1-bis(tert-butylperoxy)-3,3,5-trimethylchlorohexane, tert-butyl peroxy isopropylcarbonate (TBIC), tert-butyl peroxy 2-ethylhexyl carbonate (TBEC), tert-amyl peroxy 2-ethylhexyl carbonate, tert-hexylperoxy isopropyl carbonate, carbonoperoxoic acid, 0,0′-1,3-propanediyl OO,OO′-bis(1,1-dimethylethyl) ester, tert-butylperoxy benzoate, t-hexyl peroxy-2-ethylhexanoate, t-butyl peroxy-2-ethylhexanoate, di(4-methylbenzoyl) peroxide, laurel peroxide and cyclohexanone peroxide. Other suitable peroxide curatives are listed in U.S. Pat. No. 5,225,504 (Tatsu et al.).

The amount of free radical source used generally will be at least 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts of the curable highly fluorinated polymer.

The crosslinking using a peroxide can be performed generally by using an organic peroxide and, if desired, a coagent, which is a polyunsaturated compound comprising terminal unsaturation sites, that is incorporated into the polymer during curing to assist with peroxide curing. Exemplary coagents include: tri(methyl)allyl isocyanurate (TMAIC), triallyl isocyanurate (TAIC), tri(methyl)allyl cyanurate, poly-triallyl isocyanurate (poly-TAIC), triallyl cyanurate (TAC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and combinations thereof. Another useful coagent may be represented by the formula CH₂═CH—R_{f1}—CH═CH₂ wherein R_{f1} may be a perfluoroalkylene of 1 to 8 carbon atoms. Coagents may be especially useful when using the monofuctional oligomer of Formula (I).

In one embodiment, fillers, such as organic and inorganic fillers may be added to the curable composition. Fillers include: an organic or inorganic filler such as clay, silica (SiO₂), alumina, iron red, talc, diatomaceous earth, barium sulfate, wollastonite (CaSiO₃), calcium carbonate (CaCO₃), calcium fluoride, titanium oxide, iron oxide and carbon black fillers, a polytetrafluoroethylene powder, PFA (TFE/perfluorovinyl ether copolymer) powder, an electrically conductive filler, a heat-dissipating filler, and the like may be added as an optional component to the composition. Those skilled in the art are capable of selecting specific fillers at required amounts to achieve desired physical characteristics in the vulcanized compound. The filler components may result in a compound that is capable of retaining a preferred elasticity and physical tensile, as indicated by an elongation and tensile strength value. In one embodiment, the curable composition comprises at least 1, 2, and even 5% and less than 40, 30, 20, 15, or even 10% by weight of the filler.

Conventional adjuvants may also be incorporated into the composition of the present disclosure to enhance the properties of the resulting composition. For example, acid acceptors may be employed to facilitate the cure and thermal stability of the compound. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, or combinations thereof. The acid acceptors are preferably used in amounts ranging from about 1 to about 20 parts per 100 parts by weight of the highly fluorinated polymer.

In one embodiment, the curable composition is substantially free (in other words, comprises less than 1, 0.5, 0.1, 0.05, or even 0.01% by weight versus the highly fluorinated polymer) of a secondary processing aid. Exemplary secondary process aides include: wax, for example carnauba wax; commercially available plasticizers for example those available from Struktol Co., Stow, Ohio, such as those available under the trade designation “STRUKTOL WB222”, “STRUKTOL WS280”, and “STRUKTOL HT290”; and slip agents such as zinc stearate.

The curable fluoropolymer compositions may be prepared by mixing the curable highly fluorinated polymer and the curable oligomer, along with the other components (e.g., the peroxide, coagent and/or fillers) in conventional rubber processing equipment to provide a solid mixture, i.e. a solid polymer containing the additional ingredients, also referred to in the art as a “compound”. This process of mixing the ingredients to produce such a solid polymer composition containing other ingredients is typically called “compounding”. Such equipment includes rubber mills, internal mixers, such as Banbury mixers, and mixing extruders. The temperature of the mixture during mixing typically will not rise above about 120° C. During mixing the components and additives are distributed uniformly throughout the resulting fluorinated polymer “compound” or polymer sheets.

The curable composition may be processed and shaped such as by extrusion or molding to form an article of various shapes such as sheet, a hose, a hose lining, an o-ring, a gasket, or a seal composed of the composition of the present disclosure. The shaped article may then be heated to cure the curable composition and form a cured highly fluorinated polymer article.

Pressing of the compounded mixture (i.e., press cure) is typically conducted at a temperature of about 120-220° C., preferably about 140-200° C., for a period of about 1 minute to about 15 hours, usually for about 1-15 minutes. A pressure of about 700-20,000 kPa, preferably about 3400-6800 kPa, is typically used in molding the composition. The molds first may be coated with a release agent and prebaked.

The molded vulcanizate can be post cured in an oven at a temperature of about 140-240° C., preferably at a temperature of about 160-230° C., for a period of about 1-24 hours or more, depending on the cross-sectional thickness of the sample. For thick sections, the temperature during the post cure is usually raised gradually from the lower limit of the range to the desired maximum temperature. The maximum temperature used is preferably about 260° C., and is held at this value for about 1 hour or more.

Although not wanting to be limited by theory, it is believed that the curable oligomers disclosed herein are covalently bound in the composition either to the highly fluorinated polymer and/or the coagent, as demonstrated by the minimal weight loss observed in heat-aging studies of the cured fluoropolymers. In one embodiment, the curable oligomers disclosed herein are covalently bond to the highly fluorinated polymer. In one embodiment, the highly fluorinated polymer has a —CF₂—Y end group, where Y is —Br or —I, and the resulting polymer comprises a plurality of segments (e.g., at least 2, 3, 4, 5, 10, 20, etc.) such as those disclosed below.

In one embodiment, the cured composition comprises a highly fluorinated polymer having a plurality of segments, the segments comprising at least one of the following:

R-L-CHYCH₂—CF₂—,
R-L-CH₂CHYCH₂—CF₂—,
R-L-OCHYCH₂—CF₂—,
R-L-OCH₂CHYCH₂—CF₂—,
R-L-OCH₂C(CH₃)YCH₂—CF₂—,
R-L-C(CH₃)YCH₂—CF₂—, and
R-L-OCFYCF₂—CF₂—,
where Y is —I or —Br;
n is 1 or 2;
L comprises at least one of a bond, —CH₂OC(═O)—, —CH₂OC(═O)NHCH₂CH₂OC(═O)—, and —C(═O)NHCH₂CH₂OC(═O)—; and
R is a monovalent perfluoro polyether alkyl group as defined above
wherein the segment has a number average molecular weight of 1000-16,000 g/mol.

In one embodiment, the cured composition comprises a highly fluorinated polymer having a plurality of segments, the segments comprising at least one of the following:

R¹-(L-CHYCH₂—CF₂—)₂,
R¹-(L-CH₂CHYCH₂—CF₂—)₂,
R¹-(L-OCHYCH₂—CF₂—)₂,
R¹-(L-OCH₂CHYCH₂—CF₂—)₂,
R¹-(L-OCH₂C(CH₃)YCH₂—CF₂—)₂, and
R¹-(L-C(CH₃)YCH₂—CF₂—)₂
where Y is —I or —Br;
n is 1 or 2
L comprises at least one of a bond, —CH₂OC(═O)—, —CH₂OC(═O)NHCH₂CH₂OC(═O)—, and —C(═O)NHCH₂CH₂OC(═O)—; and
R¹ is a divalent perfluoro polyether alkylene group as defined above wherein the segment has a number average molecular weight of 1000-6000 g/mol.

In one embodiment, the highly fluorinated polymer in the curable composition has a Mooney viscosity in accordance with ASTM D1646-06 TYPE A by a MV 2000 instrument (available from Alpha Technologies, Ohio, USA) using large rotor (ML 1+10) at 121° C. Upon curing, the highly fluorinated polymer becomes a non-flowing fluoropolymer, having an infinite viscosity (and therefore no measurable Mooney viscosity).

In one embodiment, the cured composition is opaque or translucent, meaning that the cured composition is not optically clear. As used herein, optically clear refers to the material having light transmission in the visible range (400-750 nm) of at least 75, 80, or even 85% on a sample of 5 micrometers as measured by ASTM D-1003-13.

In one embodiment of the present disclosure, the cured composition has a glass transition temperature of less than 20, 10 or even 5° C., but not lower than 0, −5, −10, −15, −20, −25, or even −30° C.

The cured fluoroelastomer is particularly useful in automotive, chemical processing, semiconductor, aerospace, and petroleum industry applications, among others.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

The following abbreviations are used in this section: mL=milliliters, g=grams, lb=pounds, min=minutes, h=hours, NMR=nuclear magnetic resonance, eq=equivalent, mmHg=millimeters mercury, ° C.=degrees Celsius, ° F.=degrees Fahrenheit, phr=parts per hundred rubber, MPa=mega Pascal, psi=pounds per square inch, N m=Newton meter, kN=kilonewton, and kN/m=kilo Newton per meter, FPE=functionalized polyether. Abbreviations for materials used in this section, as well as descriptions of the materials, are provided in Table 1.

TABLE 1

| Material | Details |
|---|---|
| FPE-1 | C₃F₇O—[CF(CF₃)CF₂O]ₙCF(CF₃)CH₂OCH₂CH═CH₂, prepared as described |
| | below, Mn = 1350 g/mol |
| FPE-2 | C₃F₇O—[CF(CF₃)CF₂O]ₙCF(CF₃)C(═O)OCH₃, can be prepared as described |
| | below; Mn = 16,000 g/mol |
| FPE-3 | C₃F₇O[CF(CF₃)CF₂O]ₙCF(CF₃)CH₂OC(═O)CH═CH₂, prepared as |
| | described below; Mn = 1250 g/mol |
| FPE-4 | CH₂═CHC(═O)OCH₂CF(CF₃)[OCF₂CF(CF₃)]ₙ—OC₄F₈O— |
| | [CF(CF₃)CF₂O]ₙCF(CF₃)CH₂OC(═O)CH═CH₂ prepared as described for |
| | preparation of HFPO Diacrylate in U.S. Pat No. 10,023,736 (Corvelyn et |
| | al.); Mn = 1465 g/mol |
| FPE-5 | CH₂═CHC(═O)OCH₂—CF₂O(CF₂CF₂O)ₘCF₂O)ₙCF₂—CH₂OC(═O)CH═CH₂ |
| | made as described for FPE-2 in U.S. Pat. Appl. No. 2013084459 (Larson |
| | et al.): Mn = 2200 g/mol |
| FPE-6 | C₃F₇O[CF(CF₃)CF₂O]ₙCF(CF₃)C(═O)NHCH₂CH₂OC(═O)C(CH₃)═CH₂ |
| | can be prepared as described for FPE-6 in U.S. Pat. Appl. No. 2013084459 |
| | (Larson et al.); Mn = 1300 g/mol |
| FPE-7 | C₃F₇O—[CF(CF₃)CF₂O]ₙCF(CF₃)C(═O)NHCH₂CH₂OC(═O)CH═CH₂, |
| | prepared as described in US Pat. Publ. No. 2013084459 as FPE-5, Mn = |
| | 1425 g/mol |
| FPE-8 | CH₂═C(CH₃)C(═O)OCH₂CH₂NHC(═O)OCH₂— |
| | CF₂O(CF₂CF₂O)ₘ(CF₂O)ₙCF₂— |
| | CH₂OC(═O)NHCH₂CH₂OC(═O)C(CH₃)═CH₂, can be prepared by |
| | preparing Example VI as described in US Pat. No. 4,094,911 (Mitsch et |
| | al.) and reacting it with 2-isocyanatoethyl methacrylate (available from |
| | Sigma-Aldrich) in the presence of triethylamine in MTBE solvent and |
| | isolating; Mn = 2370 g/mol |
| Fluoroelastomer A | A perfluoroelastomer is derived from about 49.2% of TFE, 50.3% of |
| | PMVE and 0.5% of CF₂═CFO(CF₂)₃O(CF₂)₂I by weight, 72.2% fluorine |
| | content by weight, 0.31% iodine content by weight and Mooney Viscosity |
| | ML1 + 10 @ 121° C. of 35. |
| N990 | Carbon black, available under the trade designation “N990” from Cancarb |
| | Ltd, Medicine Hat, Alberta, Canada |
| TAIC DLC-A | A co-agent. 72% triallyl isocyanurate on silicon dioxide commercially |
| | available from Natrochem, Inc., Savannah, GA, under the trade |
| | designation “TAIC-DLC-A” |
| DBPH-50 | A peroxide, 2,5-dimethyl-2,5-di(t-butylperoxy)-hexane, 50% active, |
| | available under the trade designation “VAROX DBPH-50” from |
| | Vanderbilt Chemicals, LLC., Norwalk, CT. |
| MTBE | Methyl tert-butyl ether, available from Sigma-Aldrich |

Preparation of FPE-1

A 3-L round bottom flask equipped with a mechanical stirrer and nitrogen bubbler was charged with 1 liter of glyme, sodium borohydride (85 g, 2.2 mol) and heated to 77° C. C₃F₇O—[CF(CF₃)CF₂O]ₙCF(CF₃)C(═O)OCH₃ (810 g, 0.8 mol) prepared as described in U.S. Pat. No. 3,322,826 by taking the acid fluoride and reacting with excess methanol, was added to the stirred slurry over one hour. An exotherm was observed and heated to 88° C. for 18 hours. Heat was removed and 300 g methanol was added over three hours with evolution of hydrogen. Reaction was quenched with a mixture of 290 g of concentrated sulfuric acid in 1 kg of water. Solvents were removed by heating to a final head temperature of 93° C. Fluorochemical lower phase was separated and vacuum heated to remove water. C₃F₇O—[CF(CF₃)CF₂O]ₙCF(CF₃)CH₂OH (688 g, 0.7 mol) was made in an 88% yield and the structure was confirmed by FTIR and H and FNMR. A 1-liter 3-neck round bottom flask was charged with 200 g, 0.16 mol oligomer C₃F₇O—[CF(CF₃)CF₂O]ₙCF(CF₃)CH₂OH, 24 g, 0.2 mol allyl bromide, 4 g 0.01 mol tetrabutyl ammonium bromide available from Aldrich stirred and heated to 50° C. Addition of 13 g 0.23 mol KOH in 30 g water was followed by heating to 70° C. for 4 hours. Reaction was followed by NMR to determine when the reaction was done. Added 100 g distilled water and collected lower phase. Vacuum stripped to 50° C. at 10 mm to recover 206 g, 0.15 mol C₃F₇O—[CF(CF₃)CF₂O]ₙCF(CF₃)CH₂OCH₂CH═CH₂ in a 76% yield having a number average molecular weight of 1350 g/mol confirmed by ¹H and ¹⁹F NMR.

Preparation of FPE-2

C₃F₇O—[CF(CF₃)CF₂O]ₙCF(CF₃)C(═O)OCH₃ was prepared as described in U.S. Pat. No. 3,322,826 but with the exception that the reaction temperature was 20° C., with hexafluoropropylene oxide added over 24 hours followed by taking the acid fluoride and reacting with excess methanol. C₃F₇O—[CF(CF₃)CF₂O]ₙCF(CF₃)C(═O)OCH₃ having a having a number average molecular weight of 16,000 g/mol confirmed by ¹H and ¹⁹F NMR.

Preparation of FPE-3

A 3-L round bottom flask equipped with a mechanical stirrer and nitrogen bubbler was charged with 1 liter of glyme, sodium borohydride (85 g, 2.2 mol) and heated to 77° C. C₃F₇O—[CF(CF₃)CF₂O]ₙCF(CF₃)C(═O)OCH₃ (810 g, 0.8 mol) prepared as described in U.S. Pat. No. 3,322,826 by taking the acid fluoride and reacting with excess methanol, was added to the stirred slurry over one hour. An exotherm was observed and the mixture was heated to 88° C. for 18 hours. Heat was removed and 300 g methanol was added over three hours with evolution of hydrogen. Reaction was quenched with a mixture of 290 g of concentrated sulfuric acid in 1 kg of water. Solvents were removed by heating to a final head temperature of 93° C. Fluorochemical lower phase was separated and vacuum heated to remove water. C₃F₇O—[CF(CF₃)CF₂O]ₙCF(CF₃)CH₂OH (688 g, 0.7 mol) was made in an 88% yield and the structure was confirmed by FTIR and H and FNMR. In a 500 ml round bottom flask equipped with a mechanical stirrer and nitrogen bubbler was charged with C₃F₇O—[CF(CF₃)CF₂O]ₙCF(CF₃)CH₂OH (50 g, 0.04 mol), 50 g glyme and 5 g triethylamine. One phase was obtained by addition of 14 g CFCl₂CF₂Cl solvent and heated to 45° C. for thirty minutes. Addition of acryloyl chloride (4.5 g, 0.05 mol) was over thirty minutes with a slight reflux and precipitate formation. Added 100 g water and isolated the lower fluorochemical phase, dried with MgSO₄, filtered and stripped dry with vacuum. C₃F₇O[CF(CF₃)CF₂O]ₙCF(CF₃)CH₂OC(═O)CH═CH₂ (42.2 g, 0.03 mol) for an 80% yield having a having a number average molecular weight of 1200 g/mol was confirmed by FTIR and ¹H and ¹⁹F NMR.

Characterization Methods

Compounding

For Examples and Counter Examples, 100.0 parts of Fluoroelastomer A were compounded with 20.0 parts N990, 2.5 parts TAIC DLC-A, 2.0 parts DBPH-50, and, if noted, a curable oligomer from Table 1, using a two roll mill.

Mooney Viscosity

The curable composition has a Mooney viscosity in accordance with ASTM D1646-06 TYPE A by a MV 2000 instrument (available from Alpha Technologies, Ohio, USA) using large rotor (ML 1+10) at 121° C.

Cure Rheology

Cure rheology tests were carried out using uncured, compounded samples using a rheometer marketed under the trade designation Monsanto Moving Die Rheometer (MDR) Model 2000 by Monsanto Company, Saint Louis, Mo., in accordance with ASTM D 5289-93a at 160° C., no pre-heat, 12 min elapsed time (unless otherwise specified), and a 0.5 degree arc. Both the minimum torque (ML) and highest torque attained during a specified period of time when no plateau or maximum torque (MH) was obtained were measured. Also measured were the time for the torque to reach a value equal to ML+0.5 (MH−ML), (t′50), and the time for the torque to reach ML+0.9 (MH−ML), (t′90).

Physical Properties

Tensile data was gathered from cured samples (press cured for 10 minutes at 160° C. and post cured for 2 hours at 232° C.) cut to Die D specifications at ambient conditions in accordance with ASTM 412-16. Samples were cut from the finished post-cured slabs and tested at standard conditions using a MTS Insight Tensiometer (MTS Systems Corp, Eden Prairie, Minn.) equipped with a 1 kN load cell, according to ASTM D471-16a (Die D) & ASTM D624-00 (Die T) respectively. Tensile strength at break, elongation at break, and 100% Modulus were reported. 100% Modulus was determined by the tensile strength at 100% elongation. To test effects of heat aging, the post-cured samples were heated at 250° C. for 70 hours or 96 hours (as indicated) in air and then cooled. The heat aged samples were tested for tensile, elongation and 100% modulus and the % change from the original is reported (Δ=(aged−original)×100%/original).

Shore A Hardness

Shore A hardness using a durometer was acquired using a Zwick/Roell HB.04.3130.000 Shore A hardness tester following ASTM D 2240-15e-1A.

Tear

Tear data was gathered from cured samples (press cured for 10 minutes at 160° C. and post cured for 2 hours at 232° C.) cut to test piece C specifications at ambient conditions in accordance with ASTM D 624-00 (2012). Samples having a thickness of about 2 mm were cut from the finished post-cured slabs and tested using a MTS Insight Tensiometer (MTS Systems Corp, Eden Prairie, Minn.).

Compression Set

O-rings (214, AMS AS568) were molded at 177° C. for 10 minutes. The press cured O-rings were post-cured at 232° C. for 4 hours. The press cured and post cured O-rings were tested for compression set for 70 hours at 200° C. in accordance with ASTM D 395-03 Method B and ASTM D 1414-94 with 25% initial deflection. Results are reported as percentages.

TABLE 2

| | CE-1 | EX-1 | EX-2 |
|---|---|---|---|
| FPE Type and amount | none | FPE-1 4.0 | FPE-2 4.1 |
| (parts) | | | |
| Total: | 124.5 | 128.5 | 128.8 |

MDR (0.5° Arc) Cure rheology, 12 mins @ 160° C.

| | | | |
|---|---|---|---|
| ML, in · lbs | 1.29 | 1.08 | 1.16 |
| T50, mins | 0.82 | 1.06 | 0.78 |
| T90, mins | 2.05 | 3.04 | 2.05 |
| MH | 27.03 | 24.44 | 23.35 |
| Tan Δ @ ML | 0.798 | 0.843 | 0.819 |
| Tan Δ @ MH | 0.038 | 0.034 | 0.043 |

TABLE 3

| | CE-2 | EX-3 | EX-4 | EX-5 | EX-6 |
|---|---|---|---|---|---|
| Amount of FPE-3 (parts) | 0 | 4.0 | 8.0 | 10.0 | 12.0 |

MDR (0.5° Arc) Cure rheology, 12 mins @ 160° C.

| | | | | | |
|---|---|---|---|---|---|
| ML, in · lbs | 0.82 | 0.66 | 0.42 | 0.36 | 0.30 |
| T50, mins | 0.95 | 1.28 | 1.39 | 1.44 | 1.57 |
| T90, mins | 2.50 | 3.28 | 3.57 | 3.71 | 4.15 |
| MH, in · lbs | 28.43 | 26.74 | 24.00 | 22.86 | 21.66 |
| Mooney Viscosity | 34.5 | 26.5 | 19.1 | 16.8 | 14.5 |
| ML (1 + 10) @ 121° C. | | | | | |

TABLE 4

| | CE-3 | EX-7 | EX-8 |
|---|---|---|---|
| FPE Type and amount | none | FPE-4 4.0 | FPE-5 4.0 |
| (parts) | | | |

MDR (0.5° Arc) Cure rheology 12 mins @ 60° C.

| | | | |
|---|---|---|---|
| ML, in · lbs | 1.51 | 1.28 | 1.05 |
| T50, mins | 0.92 | 1.20 | 1.10 |
| T90, mins | 2.35 | 2.82 | 2.64 |
| MH, in · lbs | 27.50 | 28.76 | 27.22 |

TABLE 5

| | CE-4 | EX-9 | EX-10 | EX-11 |
|---|---|---|---|---|
| Plasticizer Type and amount | none | FPE-6 4.0 | FPE-7 4.0 | FPE-8 4.0 |
| (parts) | | | | |

MDR (0.5° Arc) Cure rheology, 12 mins @ 160° C.

| | | | | |
|---|---|---|---|---|
| ML, in · lbs | 1.04 | 0.88 | 0.94 | 0.95 |
| T50, mins | 0.94 | 1.75 | 1.18 | 1.10 |
| T90, mins | 2.10 | 3.48 | 2.72 | 2.28 |
| MH, in · lbs | 28.60 | 28.12 | 27.47 | 35.60 |
| Mooney Viscosity | 42.3 | 30.3 | 31.2 | 27.1 |
| ML (1 + 10) @ 121° C. | | | | |

The improved ability to process compositions with the addition of the curable oligomer disclosed herein can be seen in the above tables. For example, in each sample run, when the comparative example was compared to the example comprising the curable oligomer, the ML decreased upon addition of the curable oligomer suggesting a material that would be easier to process, while the MH value between the comparative and the examples, while increasing slightly, indicated that the degree of cure was not substantially changed with the incorporation of the curable oligomer. Examination of the Mooney viscosity shows a lowering of Mooney viscosity with the addition of a curable oligomer to the composition.

TABLE 6

| | | |
|---|---|---|
| CE-1 | EX-1 | EX-2 |

Original Properties

| | | | |
|---|---|---|---|
| Tensile (psi) | 3097 | 2570 | 1953 |
| Elongation (%) | 160 | 159 | 131 |
| 100% Modulus (psi) | 1477 | 1247 | 1220 |
| Hardness, Shore A (pts) | 73.5 | 70.7 | 69.4 |

Heat Age (96 h @ 250° C.)

| | | | |
|---|---|---|---|
| Tensile (Δ) | −34% | −21% | 0% |
| Elongation (Δ) | 49% | 84% | 129% |
| 100% Modulus (Δ) | −54% | −49% | −59% |
| Hardness, Shore A (Δ) | −2.00 | 1.00 | −0.50 |

TABLE 7

| | | | | | |
|---|---|---|---|---|---|
| Original Properties | CE-2 | EX-3 | EX-4 | EX-5 | EX-6 |

Original Properties

| | | | | | |
|---|---|---|---|---|---|
| Tensile (psi) | 2756 | 2584 | 2788 | 2422 | 2380 |
| Elongation (%) | 143 | 164 | 197 | 188 | 204 |
| 100% Modulus (psi) | 1499 | 1134 | 868 | 837 | 711 |
| Hardness, Shore A (pts) | 73.2 | 71.8 | 70.2 | 67.1 | 66.7 |
| Tear, Die C (kN/m) | 20.9 | 20.1 | 20.7 | 19.2 | 18.2 |

Heat Age (70 h @ 250° C.)

| | | | | | |
|---|---|---|---|---|---|
| Tensile (Δ) | −15% | −10% | −23% | −9% | −8% |
| Elongation (Δ) | 41% | 51% | 35% | 52% | 61% |
| 100% Modulus (Δ) | −41% | −34% | −27% | −25% | −26% |
| Hardness, Shore A (Δ) | −0.40 | 1.10 | 2.10 | 3.70 | 4.40 |

TABLE 8

| | | |
|---|---|---|
| CE-3 | EX-7 | EX-8 |

Original Properties

| | | | |
|---|---|---|---|
| Tensile (psi) | 2871 | 2676 | 2734 |
| Elongation (%) | 157 | 161 | 170 |
| 100% Modulus (psi) | 1350 | 1265 | 1169 |
| Hardness, Shore A (pts) | 72.5 | 72.6 | 71.9 |
| Tear, Die C (kN/m) | 21.1 | 21.4 | 20.1 |

Heat Age (70 h @ 250° C.)

| | | | |
|---|---|---|---|
| Tensile (Δ) | −14% | −16% | −23% |
| Elongation (Δ) | 45% | 40% | 40% |
| 100% Modulus (Δ) | −44% | −42% | −44% |
| Hardness, Shore A (Δ) | −0.60 | −1.80 | −0.60 |

TABLE 9

| | | | |
|---|---|---|---|
| CE-4 | EX-9 | EX-10 | EX-11 |

Original Properties

| | | | | |
|---|---|---|---|---|
| Tensile (psi) | 3206 | 2886 | 2953 | 2756 |
| Elongation (%) | 170 | 184 | 182 | 181 |
| 100% Modulus (psi) | 1324 | 1118 | 1143 | 1289 |
| Hardness, Shore A (pts) | 70.3 | 71.6 | 71.5 | 75.5 |

Heat Age (70 h @ 250° C.)

| | | | | |
|---|---|---|---|---|
| Tensile (Δ) | −28% | −27% | −26% | −25% |
| Elongation (Δ) | 51% | 57% | 56% | 53% |
| 100% Modulus (Δ) | −46% | −40% | −40% | −47% |
| Hardness, Shore A (Δ) | 0.30 | 0.50 | −0.70 | −2.10 |

Physical properties of Examples showed improvement in 0% Elongation compared with the correspondingly run counter example.

TABLE 10

| | CE-2 | EX-3 | EX-4 | EX-5 | EX-6 |
|---|---|---|---|---|---|
| Compression Set (%) | 13.6 | 17.6 | 21.2 | 23.9 | 26.9 |

TABLE 11

| | CE-3 | EX-7 | EX-8 |
|---|---|---|---|
| Compression Set (%) | 15.4 | 17.4 | 18.6 |

TABLE 12

| | CE-4 | EX-9 | EX-10 | EX-11 |
|---|---|---|---|---|
| Compression Set (%) | 15.2 | 24.9 | 20.0 | 29.0 |

The compression set results indicate less resistance to compression set with the addition of the curable oligomer and/or increasing amounts of the curable oligomer.

The volatility of the curable oligomer within the cured fluoropolymer was investigated. A post-cured sample of CE-2, EX-3, EX-4, EX-5, and EX-6 was weighed. Then the sample was heated for 70 hours at 200° C., allowed to cool and then the weight was remeasured. The % weight loss, reported in Table 13, was calculated as the ratio of the weight change to the initial sample weight, multiplied by 100, and expressed as a percent.

TABLE 13

| | CE-2 | EX-3 | EX-4 | EX-5 | EX-6 |
|---|---|---|---|---|---|
| % weight loss | −0.21% | −0.63% | −1.08% | −1.35% | −1.61% |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A composition comprising:
(a) a curable highly fluorinated polymer comprising at least one of the following cure-sites: an iodine cure-site, a bromine cure-site, and a nitrile cure-site, wherein the curable highly fluorinated polymer comprises a polymer backbone, wherein the polymer backbone comprises C—F bonds and either (i) no C—H bonds or (ii) C—H bonds, but having less than 0.25% by weight of hydrogen along the polymer backbone;
(b) 4 to 25 parts of a curable oligomer per 100 parts of the curable highly fluorinated polymer, wherein the curable oligomer is
(i) a monofunctional compound of formula (I) R-L-X having a number average molecular weight of 1000-16,000 g/mol,
(ii) a difunctional compound of formula (II) is R¹-(L-X¹)₂ having a number average molecular weight of 1000-6000 g/mol, or
(iii) mixtures thereof;
where:
X comprises at least one of:
—CH═CH₂, —CH₂CH═CH₂, —OCH═CH₂, —OCH₂CH═CH₂, —OCH₂C(CH₃)═CH₂,
—C(CH₃)═CH₂, and —OCF═CF₂;
X¹ comprises at least one of:
CH═CH₂, —CH₂CH═CH₂, —OCH═CH₂, —OCH₂CH═CH₂, —OCH₂C(CH₃)═CH₂, and
—C(CH₃)═CH₂;
L comprises at least one of a bond, —CH₂OC(═O)—, —CH₂OC(═O)NHCH₂CH₂OC(═O)—, and —C(═O)NHCH₂CH₂OC(═O)—;
R is a monovalent perfluoro polyether alkyl group; and
R¹ is a divalent perfluoro polyether alkylene group.

2. The composition of claim 1, wherein R comprises at least one of
CF₃CF₂CF₂O[CF(CF₃)CF₂O]ₘ—CF(CF₃)— where m is an integer from 5 to 100;
CF₃O[CF₂CF₂O]ₙ—CF₂— where n is an integer from 8 to 100;
CF₃CF₂O[(CF₂CF₂O)ₚ(CF₂O)_{q}]—CF₂— wherein [(CF₂CF₂O)ₚ(CF₂O)_{q}] is a random unit comprising at least 5 (CF₂CF₂O) units and at least 5 (CF₂O) units and the sum of p+q is an integer from 10 to 40;
CF₃CF₂CF₂CF₂O[CF₂CF₂CF₂CF₂O]ₛ—CF₂CF₂CF₂— where s is an integer from 3 to 100; and
CF₃CF₂CF₂O[CF₂CF₂CF₂O]ₜ—CF₂CF₂— where t is an integer from 8 to 100.

3. The composition of claim 1, wherein R¹ comprises at least one of
—CF(CF₃)—(OCF₂CF(CF₃)ᵤ—O—(CF₂)ᵥ—O[CF(CF₃)CF₂O]_{w}—CF(CF₃)— where u is an integer from 2 to 50, v is an integer from 2 to 4, and w is an integer from 2 to 50;
—CF₂O[CF₂CF₂O]ₙ—CF₂— where n is an integer from 8 to 50;
—CF₂O[(CF₂CF₂O)ₚ(CF₂O)_{q}]—CF₂— wherein [(CF₂CF₂O)ₚ(CF₂O)_{q}] is a random unit comprising at least 5 (CF₂CF₂O) units and at least 5 (CF₂O) units and the sum of p+q is an integer from 10 to 40;
—CF₂CF₂CF₂O[CF₂CF₂CF₂CF₂O]ₛ—CF₂CF₂CF₂— where s is an integer from 3 to 100; and
—CF₂CF₂O[CF₂CF₂CF₂O]ₜ—CF₂CF₂— where t is an integer from 5 to 100.

4. The composition of claim 1, wherein the curable oligomer is at least one of:
CF₃CF₂CF₂O—(CF(CF₃)CF₂O)ₙ—CF(CF₃)—CH₂OC(═O)CH═CH₂;
CF₃CF₂CF₂O—(CF(CF₃)CF₂O)ₙ—CF(CF₃)—CH₂OCH₂CH═CH₂;
CH₂═CHC(═O)OCH₂—CF(CF₃)[OCF₂CF(CF₃]ᵤ—O—(CF₂)ᵥ—O[CF(CF₃)CF₂O]_{w}—CF(CF₃)—CH₂OC(═O)CH═CH₂; and
CH₂═CHC(═O)OCH₂—CF₂O[(CF₂CF₂O)ₚCF₂O)_{q}]CF₂—CH₂OC(═O)CH═CH₂;
wherein n is an integer from at least 5 and at most 100, u is an integer of at least 2 and at most 50;
v is an integer of at least 2 and at most 50, w is an integer of at least 2 and at most 50, and wherein [(CF₂CF₂O)ₚ(CF₂O)_{q}] is a random unit comprising at least five (CF₂CF₂O) units and at least five (CF₂O) units and the sum of p+q is an integer of at least 10 and at most 40.

5. The composition of claim 1, wherein the curable highly fluorinated polymer is derived from at least one of tetrafluoroethylene, hexafluoropropylene, perfluorinated vinyl ethers, perfluorinated allyl ethers, perfluorinated alkyl vinyl monomers, fluorinated bisolefins, and mixtures thereof.

6. The composition of claim 1, wherein the curable highly fluorinated polymer is derived from at least 30 wt % of perfluorinated vinyl ether monomers, perfluorinated allyl ether monomers, or mixtures thereof.

7. The composition of claim 1, further comprising a peroxide.

8. (canceled)

9. The composition of claim 7, further comprising a coagent wherein the coagent comprises at least one of the following: (i) triallyl isocyanurate, (ii) tri(methyl)allyl isocyanurate, (iii) tri(methyl)allyl cyanurate, (iv) poly-triallyl isocyanurate, (v) xylylene-bis(diallyl isocyanurate), and (vi) CH₂═CH—R_{fl}—CH═CH₂ wherein R_{fl} may be a perfluoroalkylene of 1 to 8 carbon atoms.

10. The composition of claim 1, further comprising a filler.

11. The composition of claim 10, wherein the filler comprises at least one of the following: carbon black, diatomaceous earth, silica, and clay.

12. (canceled)

13. The composition of claim 1, wherein the composition is substantially free of a secondary process aid.

14. The composition of claim 1, wherein the modulus at 100° C. of the composition is less than 10% of the modulus of an identical composition not including the curable oligomer.

15. (canceled)

16. An article comprising a cured composition derived from the composition of claim 1.

17. The article of claim 16, wherein the cured composition has a glass transition temperature of not lower than −20° C.

18. The article of claim 16, wherein the article is a hose, an o-ring, a gasket, or a seal.

19. The article of claim 16, wherein the article is opaque or translucent.

20. A composition comprising:
a highly fluorinated polymer having a plurality of segments, wherein the highly fluorinated polymer comprises a polymer backbone, wherein the polymer backbone comprises C—F bonds and either (i) no C—H bonds or (ii) C—H bonds, but having less than 0.25% by weight of hydrogen along the polymer backbone, the segments comprising at least one of:
R-L-CHYCH₂—CF₂—,
R-L-CH₂CHYCH₂—CF₂—,
R-L-OCHYCH₂—CF₂—,
R-L-OCH₂CHYCH₂—CF₂—,
R-L-OCH₂C(CH₃)YCH₂—CF₂—,
R-L-C(CH₃)YCH₂—CF₂—, and
R-L-OCFYCF₂—CF₂—,
where Y is —I or —Br;
L comprises at least one of a bond, —CH₂OC(═O)—, —CH₂OC(═O)NHCH₂CH₂OC(═O)—, and —C(═O)NHCH₂CH₂OC(═O)—; and
R is a monovalent perfluoro polyether alkyl group,
wherein the segment has a number average molecular weight of 1000-16,000 g/mol; or
R¹-(L-CHYCH₂—CF₂—)₂,
R¹-(L-CH₂CHYCH₂—CF₂—)₂,
R¹-(L-OCHYCH₂—CF₂—)₂,
R¹-(L-OCH₂CHYCH₂—CF₂—)₂,
R¹-(L-OCH₂C(CH₃)YCH₂—CF₂—)₂, and
R¹-(L-C(CH₃)YCH₂—CF₂—)₂
where Y is —I or —Br;
L comprises at least one of a bond, —CH₂OC(═O)—, —CH₂OC(═O)NHCH₂CH₂OC(═O)—, and —C(═O)NHCH₂CH₂OC(═O)—; and
R¹ is a divalent perfluoro polyether alkylene group
wherein the segment has a number average molecular weight of 1000-6000 g/mol.

21. (canceled)

22. A method of making a cured fluoropolymer, the method comprising:
(a) contacting a curable highly fluorinated polymer comprising at least one of an iodine cure-site, a bromine cure-site, and a nitrile cure-site wherein the curable highly fluorinated polymer comprises a polymer backbone, wherein the polymer backbone comprises C—F bonds and either (i) no C—H bonds or (ii) C—H bonds, but having less than 0.25% by weight of hydrogen along the polymer backbone, with 4 to 25 parts of a curable oligomer per 100 parts of the curable highly fluorinated polymer and a peroxide curative to form a mixture, wherein the curable oligomer is
(i) a monofunctional compound of formula (I) R-L-X having a number average molecular weight of 1000-16,000 g/mol,
(ii) a difunctional compound of formula (II) is R¹-(L-X¹)₂ having a number average molecular weight of 1000-6000 g/mol, or
(iii) mixtures thereof;
where:
X comprises at least one of:
—CH═CH₂, —CH₂CH═CH₂, —OCH═CH₂, —OCH₂CH═CH₂, —OCH₂C(CH₃)═CH₂, —C(CH₃)═CH₂, and —OCF═CF₂;
X¹ comprises at least one of:
—CH═CH₂, —CH₂CH═CH₂, —OCH═CH₂, —OCH₂CH═CH₂, —OCH₂C(CH₃)═CH₂, and —C(CH₃)═CH₂;
L comprises at least one of a bond, —CH₂OC(═O)—, —CH₂OC(═O)NHCH₂CH₂OC(═O)—, and —C(═O)NHCH₂CH₂OC(═O)—;
R is a monovalent perfluoro polyether alkyl group; and
R¹ is a divalent perfluoro polyether alkylene group; and
(b) exposing the mixture to heat.
